(19) United States
(12) Patent Application Publication
(10) Pub. No.: US 2005/0023719 A1
(43) Pub. Date: Feb. 3, 2005

(54) Separate solidification of build material and support material in solid freeform fabrication system

(76) Inventors: Jeffrey Allen Nielsen, Corvallis, OR (US); David C. Collins, Philomath, OR (US); Shawn D. Hunter, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/628,967

(22) Filed: Jul. 28, 2003

(51) Int. Cl. B29C 35/08; B29C 41/02; B29C 71/02; B41J 2/01; B41J 2/04

(52) U.S. Cl. 264/162; 264/236; 264/308; 264/401; 264/494; 347/1; 347/54; 425/375; 425/174.4

(57) ABSTRACT

The present invention is drawn to a solid freeform fabrication system for producing a three-dimensional object. The system can include a dispensing system and a curing system. The dispensing system can be adapted to separately dispense build material and support material, wherein the build material and the support material are adapted to contact one another at an interface after being dispensed. The curing system can be adapted to harden the build material after being dispensed but before the support material is dispensed, wherein mixing between the build material and the support material is inhibited at the interface.

### FIELD OF THE INVENTION

The present invention is generally related to solid freeform fabrication systems. More particularly, the present invention relates systems for forming three-dimensional objects using ink-jet technology.

### BACKGROUND OF THE INVENTION

Solid freeform fabrication (or layer manufacturing) can be defined generally as a fabrication technology used to build a three-dimensional object using layer by layer or point by point fabrication. With this fabrication process, complex shapes can be formed without the use of a pre-shaped die or mold.

Essentially, with such a system, an object can be designed using a computer program, such as a Computer Aided Design (CAD) application. Once the object has been designed three-dimensionally, solid freeform fabrication technology enables the translation of the computer generated model into a three-dimensional object. This technology is useful in areas such as verifying a CAD model, evaluating design feasibility, testing part functionality, assessing aesthetics, checking ergonomics of design, aiding in tool and fixture design, creating conceptual models and sales/marketing tools, generating patterns for investment casting, reducing or eliminating engineering changes in production, prototyping, and providing production runs, to name a few.

Typically, a solid freeform fabrication system includes a dispensing system such as an ink-jet dispensing system, a curing or hardening system, and a build platform. The ink-jet dispensing system includes both build material for forming three dimensional objects, as well as support material for supporting the build material as it hardens. As build material and support material are in contact with one another, interface areas between the build material and the support material can lead to rough surfaces remaining on the build material once the support material is removed. As such, it would be desirable to provide a system for solid freeform fabrication that provides for some of the uses described above, and at the same time, reduces the rough surfaces of the build material upon removal of the support material.

### SUMMARY OF THE INVENTION

It has been recognized that certain systems and methods can be used for free-form fabrication of three-dimensional objects, both of which allow for improved surface finish and dimensional control by improving within-layer interfaces. Additionally, it has been recognized that such systems and methods can provide for the effective separation of waste from the build material and the support material, which in turn enables the recycling of such waste. In accordance with these and other recognitions, in one embodiment, a solid freeform fabrication system for producing a three-dimensional object can comprise a dispensing system and a curing system. The dispensing system can be adapted to separately dispense build material and support material, wherein the build material and the support material are adapted to contact one another at an interface after being dispensed. The curing system can be adapted to harden or solidify the build material after the build material is dispensed but before the support material is dispensed, wherein mixing between the build material and the support material is inhibited at the interface.

In an alternative embodiment, a method for producing a three-dimensional object can comprise steps of dispensing a build material; dispensing a support material, wherein the build material and the support material contact one another at an interface after both the build material and the support material are dispensed; and curing the build material after the build material has been dispensed but before the support material is dispensed. With this method, mixing between the build material and the support material can be inhibited at the interface.

Additional features and advantages of the invention will be apparent from the detailed description and figures that follows, which illustrates, by way of example, features of the invention.

### BRIEF DESCRIPTION OF THE DRAWINGS

Aspects of the invention can be better understood with reference to the following drawings. The components in the drawings are not necessarily to scale, emphasis instead being placed upon clearly illustrating the principles of the present invention.

FIGS. 1a to 1f provide a schematic side view of a system in accordance with an embodiment of the present invention;

FIG. 2 provides a schematic top view of another system in accordance with an embodiment of the present invention;

FIGS. 3a and 3b provide a schematic side view of a unidirectional printing system in accordance with an embodiment of the present invention;

FIGS. 4a to 4d provide a schematic side view of the system of FIGS. 3a and 3b, utilizing an alternative bidirectional printing scheme;

FIGS. 5a and 5b provide a schematic side view of bidirectional printing system in accordance with an embodiment of the present invention, which utilizes certain multiple components on a dispensing carriage;

FIGS. 6a and 6b provide a schematic side view of bidirectional printing system in accordance with an embodiment of the present invention, which utilizes certain other multiple components on a dispensing carriage; and

FIGS. 7a and 7b provide a schematic side view of bidirectional printing system in accordance with an embodiment of the present invention, which utilizes certain other multiple components on a dispensing carriage.

### DETAILED DESCRIPTION OF THE PREFERRED EMBODIMENT(S)

Before the present invention is disclosed and described, it is to be understood that this invention is not limited to the particular process steps and materials disclosed herein because such process steps and materials may vary somewhat. It is also to be understood that the terminology used herein is used for the purpose of describing particular embodiments only. The terms are not intended to be limiting because the scope of the present invention is intended to be limited only by the appended claims and equivalents thereof.

It must be noted that, as used in this specification and the appended claims, the singular forms “a,” “an,” and “the” include plural referents unless the context clearly dictates otherwise.

The term “solid three-dimensional object” or “three-dimensional object” refers to objects that are formed by the fabrication method of the present invention. Solid three-dimensional objects are sufficiently solid or firm so as to maintain a fixed volume and shape to an extent which is appropriate for use in solid freeform fabrication. In some embodiments, such objects need not be strictly rigid, such as in cases where the object formed is self supporting at minimum, or alternatively, flexible.

The term “hardening,” “curing,” “solidifying,” or the like, refers to a change that occurs when the build material and/or the support material are modified from a more liquid state to a more solid state. The process of solidifying can occur as a result of electromagnetic irradiation, e.g., UV curing, by overprinting or underprinting a reactive chemical therewith, e.g., epoxy build material jetted with an amine, or cooling or freezing a material after dispensing, for example.

“Build material” includes substances that can be used to form the bulk of the solid three-dimensional object to be formed. These build materials typically include groups that can be solidified as a result of exposure to electromagnetic irradiation, such as UV radiation, as a result of a chemical reaction with a curing agent, or as a result of reducing the temperature of the material. Build materials can include a liquid modifier admixed therewith when it is desired to alter the jettability properties, such as with respect to viscosity, surface tension, and the like. Temperature adjustment can also be used to alter the jettability properties as well. Examples of build materials that can be used include UV photopolymers, epoxies, acrylates, and urethanes. Many UV curable materials are commonly known to those skilled in the art and are used throughout the industry in a variety of systems, such as stereolithography systems, jetted photopolymer systems, and the like.

“Support material” includes substances that are deposited, such as by ink-jet technology, for the purpose of supporting overhangs of a solid three-dimensional object during the build process. This material is typically of a material that can be relatively easily removed after the build process is complete, and can be configured to be placed as determined by the object being built. For example, a voxel, or point in three-dimensional space, that defines the placement of build material, cannot be deposited in mid-air. Thus, support for such build material is needed whenever build material is being printed at a location that is not otherwise supported by a build platform or previously applied build material. Removable materials that can be used include the use of wax, patterned hardening composition, water swellable gel, readily meltable material, readily soluble material, or another material that can carry the solid three-dimensional object being built, as well as be configured to be readily removed. Removal can be by heating, chemical reaction, power washing, or other similar methods.

A “build platform” is typically the rigid substrate that is used to support the solid three-dimensional object being formed (including the build material and the support material).

The term “substrate” can include the build platform, previously deposited support material, and/or previously deposited build material, depending on the context. For example, in one embodiment, support material can be applied to a build platform to enable easy removal of the solid three-dimensional object from the build platform. In this case, the build platform is the substrate for the support material. Alternatively, previously deposited build material and/or support material can be a substrate for subsequently applied build material and/or support material. To illustrate, when laying down an initial layer of a build material and/or support material, the initial layer will typically be carried by a build platform or a removable material on the build platform. However, subsequent layers of build material and/or support material can be deposited onto the previously deposited layer substrate.

As used herein, “liquid modifier” refers to any composition that can be prepared for jetting with a build material or a support material, and which, in combination, can be jetted from a dispensing architecture, such as an ink-jet pen architecture. Optionally, the liquid modifier can be a colorant to be jetted with the build material. A wide variety of other liquid modifiers can be used with the systems and methods of the present invention. For example, such liquid modifiers that can be used include water, surfactants, organic solvents and co-solvents, buffers, biocides, sequestering agents, viscosity modifiers, as well as soluble low molecular weight monomers, oligomers, and polymers, etc.

Though liquid modifiers are described herein in some detail, it is not always required that a liquid modifier be used. In some embodiments, the build material or the support material can be configured to be jetted from an ink-jet architecture without the use of a liquid modifier. For example, a wax can be heated to a jettable temperature and cooled upon application to form a solidified build material object or support material. However, if such liquid modifiers are used, they are typically present in small amounts. An example where a liquid modifier can be added is with respect to embodiments wherein it is desired to alter the viscosity, surface tension, or the like, of the build material and/or the support material. This being stated, modification of jettable compositions with a liquid modifier is not required, and in some cases, can be undesirable.

Reference will now be made to exemplary embodiments illustrated in the drawings, and specific language will be used herein to describe the same. It will nevertheless be understood that no limitation of the scope of the invention is intended. Alterations and further modifications of the inventive features illustrated herein, and additional applications of the principles of the inventions as illustrated herein, which would occur to one skilled in the relevant art and having possession of this disclosure, are to be considered within the scope of the invention.

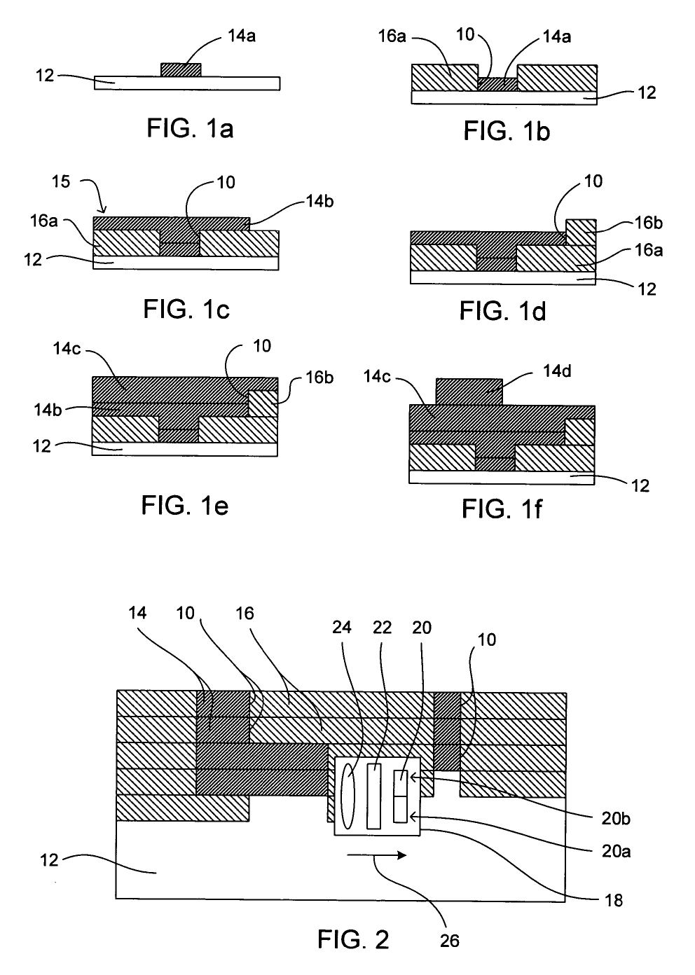

Referring now to FIGS. 1a to 1f, a system in accordance with an embodiment of the present invention is shown, wherein sequential application of build material 14 and support material 16 are applied to a build platform 12. Specifically, FIG. 1a exemplifies a build platform 12 which provides a substrate for application of a build material 14a. FIG. 1b depicts the same build platform at a later point in time, wherein support material 16a has been applied. FIG. 1c depicts the build platform at a later point in time wherein additional build material 14b has been applied. The support material 16a is shown functioning to support an overhang 15 of the build material. FIG. 1d illustrates the fabrication at a later point in time, wherein additional support material 16b has been applied. Here, support material 16a provides the substrate for the application of support material 16b. FIGS. 1e and 1f depict two additional build material layers 14c and 14d that have been applied, respectively. Build material 14c is supported by a substrate provided by build material 14b and support material 16b. Build material 14d is supported by a substrate provided by build material 14c.

At various stages during the fabrication of the three-dimensional object being formed in FIGS. 1a to 1f, junctions or interfaces 10 between the build material 14 and the support material 16 on the same layer are present. It is at these interfaces where build material and support material can be subject to cross-bleeding of one material into the next. In systems of the type shown above where the build material and the support material are solidified or cured simultaneously, there tends to be a fuzzy or rough surface formed on the vertical walls (where the build material interfaces at its vertical surfaces with the support material). This is especially true in systems where both the build and support materials are cured directly from a liquid state, or otherwise solidified simultaneously. In accordance with embodiments of the present invention, an alternative method which cures the build material and support material in separate steps can be carried out to significantly reduce this problem. This recognized solution allows for improved surface finish and dimensional control.

An additional advantage of this solution provides, in some embodiments, for the separation of waste from the build material and support material separately, which in turn enables the possibility of recycling excess material. Selective liquid-ejection systems can have a planing and/or milling process between the applications of each layer. This planing process can be implemented to compensate for variations in drop volume or directionality that can subsequently result in variations in layer thickness. For example, to compensate, layers can be intentionally printed overly thick and then planed down to a known controlled height using a planing process, e.g., using a heated roller, as will be shown in FIGS. 2 to 7 hereafter. If the material that is planed off during this process is a mix of build and support material, such mixing of this waste can cause several problems, which are solved by some embodiments of the present invention. For example, the mixing of waste can inhibit the recycling of the support material for reuse.

As exemplified in the embodiment shown in FIGS. 1a to 1f, the milled height of build material 14 and the milled height of the support material 16 are offset. This can be accomplished by incrementally lowering the height of the build platform between applications of build material and support material, or vice versa. For example, using this method, the build platform starts at a height that is less than the height of a full support layer. The incremental lowering of the build platform is shown to be about half a default layer height, though this is not intended to imply any particular amount of height offset is preferred. At this height, build material can be printed, milled, and cured according to object geometry for that layer. The build platform can then be lowered to the height of a full layer of support material. Support material can then be printed, milled, and cured as per the normal process. The build platform can then be lowered to a height that is one layer of thickness lower than the previous build material height. Alternatively, rather than lowering the build platform, the dispensing system can be raised incrementally as well. In either embodiment, the offset in height is from the previous layer of support material and the next layer of support material. This process continues producing the object with standard thickness layers wherein the height of build material is offset from the height of the support material. In some embodiments, this method can have a speed disadvantage. Additionally, this method maintains advantages, as above, of providing for separate curing of build and support materials, and has an added advantage of eliminating cross contamination of milling rollers (not shown) when two rollers are used. For example, if a first roller is used to mill the build material, and a second roller is used to mill the support material, and the support material roller does not contact the build material, and vice versa, then no cross-contamination of waste streams will occur. Though this embodiment depicts offset height deposition of build material and support material, embodiments where both materials are deposited of uniform height can also be practiced, as will be exemplified hereinafter.

One factor that differentiates embodiments of the present invention with those of the prior art is that the build material and the support material can be solidified or cured separately and sequentially. The following several embodiments, some of which have the additional benefit of separating the waste streams of the build material and support material, exemplifies these points. It should be noted that this list of embodiments is not considered to be exhaustive, but rather exemplary. While all of the examples describe dispensing and solidifying or curing the build material first and the support material second, the reverse order is also workable, and sometimes preferable. For example, it may be desirable to dispense support material first in order to provide a layer that can be easily removed to separate the build material from the build platform. Alternatively, though curing of both the build material and the support material is shown, the selective deposition systems of the present invention can be configured such that only the build material is cured. In such an embodiment, the support material can be a phase change material that solidifies after being ejected, without curing or hardening.

Referring specifically to FIG. 2, a top view of a system in accordance with embodiments of the present invention is exemplified. In this embodiment, the application of a single layer of build material 14 and support material 16 on a build platform 12 is shown. Though the substrate in FIG. 2 is a build platform, it is understood that the substrate could also be previously applied build material and/or support material. Additionally, multiple interfaces 10 are shown wherein build material and support material are contacted on a vertical surface. A dispensing carriage 18 is also provided that carries a printhead assembly 20, a milling roller or planer 22, and a UV lamp 24. In this embodiment, the printhead assembly ejects both build material and support material as the carriage travels in direction 26. This embodiment shows a unidirectional printing mode, though bidirectional printing modes can also be used, as will be described hereafter. As the printhead assembly is located in the forward most position with respect to the direction of carriage travel, the roller is in position to follow build material and support material ejection. After milling with the roller, the UV lamp is positioned to cure or harden the material previously ejected and milled by the printhead assembly and roller, respectively. As shown, the printhead assembly includes a build material ejection system 20a and a support material ejection system 20b. In the embodiment shown, the printhead assembly is in a staggered configuration, enabling the deposition of two rows of material at the same time, e.g., build material on one row and support material on another row. This configuration can complicate the carriage assembly, but also, can improve the fabrication speed.

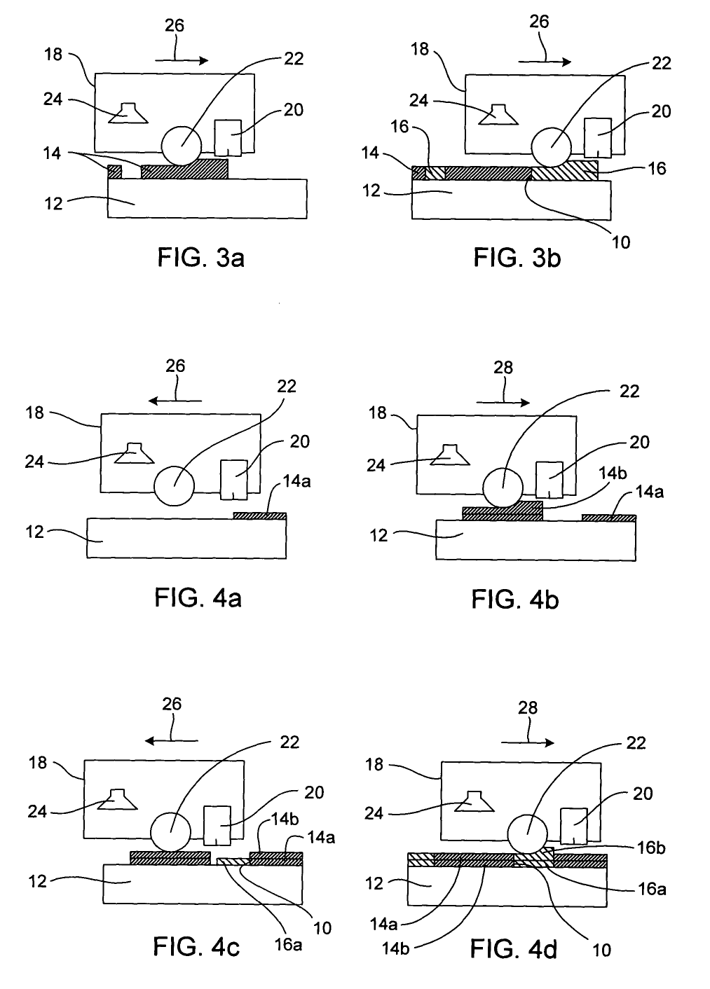

Referring now to FIGS. 3a and 3b, a side view of a system similar to that shown in FIG. 2 is provided, which also reduces cross-bleeding of materials at an interface 10. However, in this system, a two-pass unidirectional printmode is shown. The dispensing carriage 18 includes a printhead assembly 20, a milling roller or planer 22, and a UV lamp 24. In this embodiment, the printhead first ejects the build material 14, mills the build material with the roller, and cures the build material with the UV lamp as the carriage passes in direction 26. The carriage is then repositioned to return to a starting position (not shown) and the build platform is lowered in preparation for dispensing the support material 16 to fill the gaps left open by the build material deposition. Once repositioned, the carriage makes a second pass, depositing support material as the carriage travels in direction 26 a second time. As the printhead assembly is located in the forward most position with respect to the direction of carriage travel, the roller is in position to follow build material and support material upon ejection. After milling with the roller, the UV lamp is positioned to cure or harden the material previously ejected and milled by the printhead assembly and roller, respectively. Thus, prior to depositing the support material, the build material has been deposited, milled, and at least partially cured. While this particular approach has the disadvantage of requiring more print time (as it requires four total passes over a layer, during which two passes are used for dispensing and two passes are used for returning), the curing of build material and support material are kept separate, and the carriage assembly is mechanically simple compared to other possible systems that can be used in accordance with embodiments of the present invention.

Referring now to FIGS. 4a to 4d, the same dispensing carriage 18 shown in FIGS. 3a and 3b can be configured to dispense the build material and support material in a different manner, while inhibiting cross-bleeding of materials at an interface 10. In this embodiment, a bidirectional deposition can be used to dispense a first layer of build material 14a in a first direction 26 and a second layer of build material 14b in a second direction 28 using the printhead assembly 20. The roller 22 and the UV lamp 24 can be used to plane and cure the build material 14a, 14b, when the carriage is moving in the second direction. The movement in the second direction causes the carriage to return to a starting point for deposition of a first layer of support material 16a and a second layer of support material 16b, which also can optionally be milled and cured in a similar manner. This approach provides a method of bidirectional printing using only a dual composition-containing printhead assembly, milling roller, and UV lamp. However, only every other layer is planed or milled. As long as the layers are thin enough, this approach does not significantly affect the finished quality of the object.

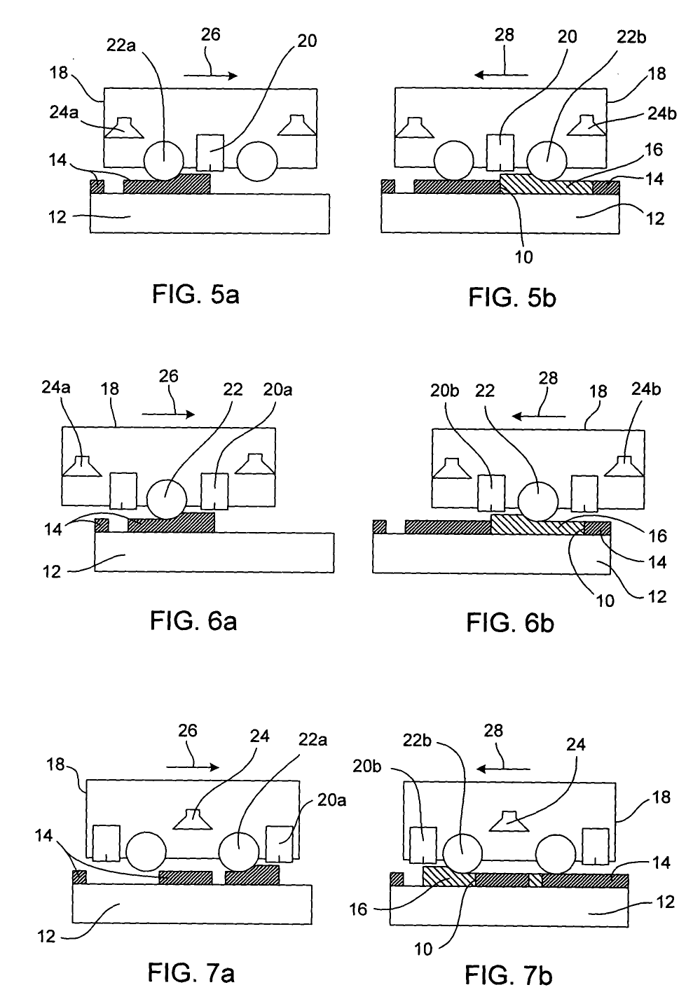

Turning now to FIGS. 5a and 5b, a carriage system 18 is shown that includes a printhead assembly 18, two milling rollers 22a, 22b, and two UV lamps 24a, 24b. The printhead assembly is configured to eject both build material and support material, and can be configured to be at the relative center of the carriage. The printhead assembly is flanked by two milling rollers, followed by two more laterally positioned UV lamps. Using this particular system, a two-pass bidirectional printmode can be employed which will dispense build material 14 in one direction and support material 16 in the other direction, while inhibiting cross-bleeding between the materials at an interface. For example, movement of the dispensing carriage 18 in a first direction 26 is used to dispense build material, followed by the roller 22a and the UV lamp 24a effecting planing and curing of the deposited build material, respectively. Next, movement of the dispensing carriage 18 (along the same layer) in a second direction 28 is used to dispense support material, followed by the roller 22b and the UV lamp 24b effecting planing and curing of the deposited support material, respectively. While this assembly has the disadvantage of having the added cost of two roller assemblies and two UV lamps, the curing of the build material and support material is kept separate, and the waste streams from the two rollers are also kept separate.

Referring now to FIGS. 6a and 6b, a dispensing carriage 18 is shown that includes two separate printhead assemblies 20a, 20b, one milling roller 22, and two UV lamps 24a, 24b. The single roller can be in the relative center of the carriage, being flanked by the two printheads, followed by two more laterally positioned UV lamps. In this embodiment, a first printhead assembly 20a ejects the build material 14 and a second printhead assembly 20b ejects the support material 16. In this system, a two-pass bidirectional printmode can be employed which will dispense build material in a first direction 26 and support material in a second direction 28, while inhibiting cross-bleeding between the materials at an interface 10. If, for example, the carriage movement in direction 26 is used to dispense build material, then printhead assembly 20a, the center roller, and UV lamp 24a can be used to deposit, plane, and cure the build material, respectively. This process can be followed by dispensing the support material using printhead assembly 20b, milling the deposited support material using the center roller, and curing the dispensed and milled support material using UV lamp 24b. While this embodiment exhibits the disadvantage of using the same roller for milling or planing the build material and the support material, the waste stream can still remain generally separate. This is because the roller will spin in opposite directions, depending on the direction of the carriage. Thus, the waste from the roller when moving in direction 26 can be configured to be collected on one side of the roller, and the waste from the roller when moving in direction 28 can be configured to be collected on the other side of the roller. Thus, only a small amount of contamination may be introduced into the generally separate waste streams.

Referring now to FIGS. 7a and 7b, a dispensing carriage 18 is shown that includes two separate printhead assemblies 20a, 20b, two milling rollers 22a, 22b, and a single UV lamp 24. In this embodiment, the single UV lamp is configured to be in the center of the carriage, and is flanked by the two milling rollers, followed laterally by the build printhead and the support printhead on either side. The first printhead assembly 20a can be configured to eject the build material 14, and the second printhead assembly 20b can be configured to eject the support material 16. In this system, a two-pass bidirectional printmode is employed which will dispense build material in one direction and support material in the other, while inhibiting cross-bleeding of materials at interface 10. If, for example, carriage movement in direction 26 is used to dispense build material from printhead 20a, then the roller 22a and the UV lamp can be used to plane and cure the support material, respectively. After depositing the build material as described, then the carriage can be moved along the same layer to dispense support material in direction 28. Thus, printhead assembly 20b is used to deposit the support material, and roller 22b and the UV lamp are used to plane and cure the build material, respectively. While this embodiment provides the disadvantage of requiring two roller assemblies, the curing of build material and support can be kept separate, and thus, the waste streams from the two rollers are likewise kept separate.

With respect to embodiments wherein the dispensing system is an ink-jet printing system, various techniques can be used to modify the viscosity or other jetting properties of the build material and/or support material. For example, heat can be used to liquefy material such that it becomes ink-jettable. An appropriate heat range is composition specific, and can range from 20° C. to 200° C. To provide a specific example, in one embodiment, if the build material is an acrylate, then a temperature range that can be used is from 40° C. to 150° C.

Alternatively, liquid modifier components can be added to build material and/or support material to modify properties, or colorant can be added to impart color to the finished three-dimensional object. Exemplary colorants that can be used include dyes and/or pigments. Examples of liquid modifier components that can be used, in small amounts if at all, include water, surfactants, organic solvents and co-solvents, buffers, biocides, sequestering agents, viscosity modifiers, as well as soluble low molecular weight monomers, oligomers, and polymers, etc. As mentioned, liquid modifiers are typically not added to carry the build material and/or the support material, but can optionally be added to modify jetting characteristics, such as viscosity, surface tension, or other properties.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

1. A solid freeform fabrication system for producing a three-dimensional object, comprising:
a dispensing system adapted to separately dispense build material and support material, wherein the build material and the support material are adapted to contact one another at an interface after being dispensed; and
a curing system adapted to harden the build material after being dispensed but before the support material is dispensed, wherein mixing between the build material and the support material is inhibited at the interface.

2. A system as in claim 1, wherein the dispensing system includes an ink-jet printing dispensing system.

3. A system as in claim 1, wherein the dispensing system is adapted to dispense build material before support material.

4. A system as in claim 1, wherein the dispensing system is adapted to dispense support material before build material.

5. A system as in claim 1, wherein the curing system is also adapted to harden the support material after being dispensed.

6. A system as in claim 1, wherein the build material is a UV curable material and the curing system is a UV curing system.

7. A system as in claim 1, further comprising a milling system adapted to mill the build material after being dispensed but before being hardened.

8. A system as in claim 7, wherein the milling system is also adapted to mill the support material.

9. A system as in claim 8, wherein the milling system provides a first waste stream for removing excess build material, and a second waste stream for removing support material.

10. A system as in claim 7, wherein the dispensing system, the curing system, and the milling system are present on a common printing carriage.

11. A system as in claim 10, wherein the printing carriage is configured for unidirectional printing.

12. A system as in claim 10, wherein the printing carriage is configured for bidirectional printing.

13. A system as in claim 1, further comprising a build platform configured to support the build material and the support material, said build platform also being configured to be lowered with respect to the dispensing system upon application of build material or support material.

14. A system as in claim 1, further comprising a build platform configured to support the build material and the support material, said dispensing system being configured to be raised with respect to the build platform upon application of build material or support material.

15. A system as in claim 1, further comprising a heating system configured to modify the temperature of at least one of the build material and the support material while within the dispensing system, thereby improving jettability of at least one of the build material and the support material.

16. A system as in claim 1, wherein the dispensing system is further configured to dispense the build material at a height that is offset with respect to the support material.

17. A method for producing a three-dimensional object, comprising:
dispensing a build material;
dispensing a support material, wherein the build material and the support material contact one another at an interface after being dispensed; and
curing the build material after the build material is dispensed but before the support material is dispensed, wherein mixing between the build material and the support material is inhibited at the interface.

18. A method as in claim 17, wherein the step of dispensing the build material is by ink-jet printing.

19. A method as in claim 17, wherein the step of dispensing the support material is by ink-jet printing.

20. A method as in claim 17, further comprising the step of curing the support material after the support material is dispensed but before additional build material is dispensed.

21. A method as in claim 17, wherein the step of curing is by UV curing.

22. A method as in claim 17, further comprising the step of milling the build material after being dispensed but before being cured.

23. A method as in claim 17, further comprising the step of curing the support material in preparation for dispensing additional build material.

24. A method as in claim 23, further comprising the step of milling the support material after being dispensed but before being cured.

25. A method as in claim 23, further comprising the step of dispensing additional build material such that contact between the support material and the additional build material occurs at a second interface.

26. A solid freeform fabrication system for producing a three-dimensional object, comprising:
means for separately dispensing build material and support material, wherein the build material and the support material are adapted to contact one another at an interface after being dispensed; and
means for hardening the build material after being dispensed but before the support material is dispensed, wherein mixing between the build material and the support material is inhibited at the interface.
